(19) United States
(12) Patent Application Publication
(10) Pub. No.: US 2003/0140743 A1
(43) Pub. Date: Jul. 31, 2003

(54) Screwdriver shank with a detachable attachment

(76) Inventor: Tone Ofentavsek, Slovenske Konjice (SI)

Correspondence Address: FACTOR & PARTNERS, PLC, 305 HOOVER BOULEVARD, SUITE 300, HOLLAND, MI, 49423, US

(21) Appl. No.: 10/297,007

(22) PCT Filed: May 10, 2001
(86) PCT No.: PCT/SI01/00014

(30) Foreign Application Priority Data
May 26, 2000 (SI) P-200000133

(51) Int. Cl. B25B 15/00

(52) U.S. Cl. 81/436

(57) ABSTRACT

The invention refers to the screwdriver shank with a detachable attachment that allows for easier tightening and loosening by application of a spanner. The shank (1) of the screwdriver with a detachable attachment (2), referred to in this invention is on one end flat (1a), provided for mounting of the detachable attachment (2), that is externally angular and whereof the opening (2a) is of such shape that conforms to the shape of the part (1a) of the shank (1) and that the detachable attachment (2) fits to the contact of the shank (1) and of the flat part (1a).

The invention refers to the screwdriver shank with a detachable attachment that allows for easier tightening and loosening by application of a spanner. The invention is classified as class B 25B 15/00 of the International Patent Classification.

The technical problem successfully solved by this invention involves the design and the construction of such screwdriver shank that will allow for simple manufacture and for the corresponding reliable galvanic protection of the screwdriver shank with a detachable attachment itself.

With the existing screwdrivers, in particular the bigger sizes, the shank is usually fitted with a hexagonal attachment located near the lower part of the handle and/or at the point where the screwdriver shank passes to the handle. This attachment serves as an aid at screwdriver tightening and/or loosening with the help of a spanner.

As a rule, screwdriver shanks are of round profile. In order to provide such attachment, usually in the form of a hexagonal nut, such attachment shall be stuck on a round shank and duly fixed to it on the appropriate spot. One of the known solutions envisages welding of the attachment to the screwdriver shank from both sides. It is a bad solution because one of the welded seams is visible even upon the mounting of the handle to the shank. Another solution involves unilateral welding, i.e. on the side covered by the screwdriver handle. As the galvanic protection of the screwdriver shank welded in this way can only be effected upon the mounting of the attachment and welding, the non-welded contact of the attachment and the shank usually shows insufficient galvanic protection. The attachment can also be machined by turning the whole shank with the attachment, which makes the manufacture of such shank much more expensive because the shank must be heated and compressed and subsequently machined to a hexagonal attachment. As the hexagonal attachment is of limited length, it is relatively short and difficult to manufacture within the range of tolerance. Further, the manufacture and the mounting of the handle to the above shank is extremely difficult, also because of more difficult insertion of shanks.

All such round shanks with the attachment, usually in the form of a hexagonal nut, shall be provided on their upper end, subsequently bearing the handle, with a flat or any other type of upper end that provides for appropriate strengthening of the handle as well as for protection against turning of the handle towards the screwdriver shank.

The screwdriver shank with a detachable attachment referred to in the invention consists of a flat upper part, subsequently covered by the handle, while the detachable attachment, corresponding to the flat part of the shank, is shaped centrically to the respective opening.

The invention will be explained in detail on the basis of the concrete example and the corresponding figures, whereof:

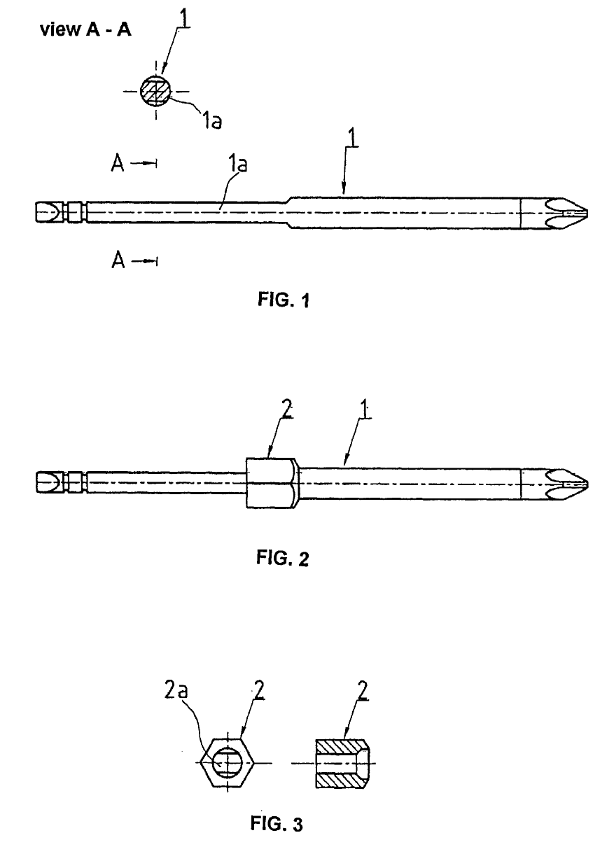

FIG. 1 shows the screwdriver shank and the detachable attachment referred to in this invention, as a lateral view, before the mounting of the detachable attachment;

FIG. 2 shows the screwdriver shank with the mounted detachable attachment referred to in this invention, as lateral view;

FIG. 3 shows the detachable attachment referred to in this invention, as top view and lateral view.

The screwdriver shank with a detachable attachment, as shown in FIGS. 1 through 3, eliminates the deficiencies of the above mentioned versions of screwdriver shanks with attachments. The shank 1 is in the part 1a, subsequently covered by the handle, flat, i.e. its essentially round profile is provided with flat surfaces on the top and on the bottom. This flatness allows for mounting of the detachable attachment 2 whereof the opening 2a is of the shape corresponding to the shape of part 1a of the shank 1. In this way the detachable attachment 2 is self-protected against rotation and needs no additional fixing. Both parts, the shank 1 and the attachment 2, may be additionally galvanically protected against the mounting of the attachment 2 to part 1a of the shank 1, which enables high quality galvanic protection of both parts. The contact of the attachment 2 and the shank 1, visible upon the mounting of the handle is therefore free of any visible welds or damaged galvanic protection.

The proposed version of the screwdriver shank with a detachable attachment fully solves the imposed technical problem and provides for a more simple and above all for a more reliable solution than known hitherto.

1. The screwdriver shank with a detachable attachment,
characterized in that
the shank (1) of the screwdriver is on one end flat (1a), provided for mounting of the detachable attachment (2), that is externally angular and whereof the opening (2a) is of such shape that conforms to the shape of the part (1a) of the shank (1) and that the detachable attachment (2) fits to the contact of the shank (1) and of the flat part (1a).

2. The screwdriver shank with a detachable attachment,
characterized in that
the detachable attachment (2) is hexagonal in shape.
